(19) United States
(12) Patent Application Publication
(10) Pub. No.: US 2025/0093884 A1
(43) Pub. Date: Mar. 20, 2025

(54) SELF-PROPELLED AGRICULTURAL WORK MACHINE WITH IMAGE-BASED CONTROL

(71) Applicant: CLAAS Selbstfahrende Erntemaschinen GmbH, Harsewinkel (DE)

(72) Inventors: Bastian Bormann, Gütersloh (DE); Waldemar Thiesmann, Osnabrück (DE); Christoph Bussmann, Harsewinkel (DE); Timo Korthals, Leopoldshöhe (DE); Dennis Neitemeier, Lippetal (DE); Andreas Wilken, Bissendorf (DE); Maik Heufekes, Münster (DE); Torben Töniges, Bielefeld (DE)

(73) Assignee: CLAAS Selbstfahrende Erntemaschinen GmbH, Harsewinkel (DE)

(21) Appl. No.: 18/886,006

(22) Filed: Sep. 16, 2024

(30) Foreign Application Priority Data
Sep. 14, 2023 (DE) 102023124856.1

(51) Int. Cl. G05D 1/65; A01D 41/127; G05D 105/15; G05D 107/20; G05D 111/10; G06V 10/75; G06V 20/10; G06V 20/56

(52) U.S. Cl. CPC G05D 1/65; A01D 41/1271; A01D 41/1274; G06V 10/751; G06V 20/188; G06V 20/56; G05D 2105/15; G05D 2107/21; G05D 2111/10

(57) ABSTRACT

A self-propelled agricultural working machine. The self-propelled agricultural working machine includes working units for collecting, processing and forwarding harvested material of a crop, a drive motor for driving the working units and propelling the self-propelled agricultural work machine at a travel speed, a camera device for capturing a digital image of the crop. A processor determines the available proportion of the harvested material based on the digital image and automatically adjusts the self-propelled agricultural work machine based thereon, including automatically adjusting the working units and/or the travel speed.

### CROSS REFERENCE TO RELATED APPLICATION

This application claims priority under 35 U.S.C. § 119 to German Patent Application No. DE 10 2023 124 856.1 filed Sep. 14, 2023, the entire disclosure of which is hereby incorporated by reference herein.

### TECHNICAL FIELD

The present invention relates to a self-propelled agricultural work machine with working units for collecting, processing and forwarding harvested material of a crop of an agricultural field, and with a drive motor for driving these working units and for propelling the self-propelled agricultural working machine at a traveling speed along the agricultural field. The self-propelled agricultural work machine may additionally have a camera device for capturing the crop of the agricultural field in the form of digital image(s) in surroundings that surrounding the self-propelled agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

EP 3 991 539 A1 discloses an electronic data processor that is configured to identify component pixels of a harvestable plant component within the received image data corresponding to plant pixels of one or more target plants. An edge, boundary or outline of the component pixels is determined. The data processor is configured to recognize a size of the harvestable plant component based on the determined edge, boundary, or outline of the identified component pixels. A user interface is configured to provide, based on a detected size of the harvestable crop component for the one or more target plants, a total yield, a partial yield, or a yield per row as an indicator of the yield of the one or more plants or the standing crop in the field.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a side view of a self-propelled agricultural work machine in use on an agricultural field.

FIG. 2 illustrates a top view during agricultural use of the self-propelled agricultural work machine.

FIG. 3 illustrates a digital image that was captured by a camera device of the self-propelled agricultural work machine according to the invention during use on an agricultural field.

FIG. 4 illustrates an enlarged section of the digital image in FIG. 3.

### DETAILED DESCRIPTION

As discussed in the background, EP 3 991 539 A1 discloses providing, based on a detected size of the harvestable crop component for the one or more target plants, a total yield, a partial yield, or a yield per row as an indicator of the yield of the one or more plants or the standing crop in the field. Such an indicator may be considered interesting and/or important for a driver of the self-propelled agricultural work machine. However this display of the indicator on the user interface does not help inexperienced drivers, or even experienced drivers in new, unknown situations in such a way that the driver may easily and reliably recognize how a desired yield may be achieved.

In one or some embodiments, a self-propelled agricultural work machine is disclosed, which relieves the driver of the self-propelled agricultural work machine and at the same time enables an optimum yield to be achieved.

In one or some embodiments, the available proportion of the harvested material is determined in the image (such as in the digital image) in order to optimally adjust the self-propelled agricultural work machine on this basis. This may enable camera image-based control of the self-propelled agricultural work machine.

In one or some embodiments, the self-propelled agricultural work machine may comprise a self-propelled forage harvester or a self-propelled combine harvester for agricultural use on an agricultural field.

The self-propelled agricultural work machine may have one or more working units, such as a plurality of working units for performing any one, any combination, or all of collecting, processing and forwarding harvested material from a crop in the agricultural field. Such a working unit may be any one, any combination, or all of an attachment attachable to the work machine, an inclined conveyor of the work machine, a threshing device of the work machine, a separating device of the work machine, a cleaning device of the work machine, a grain elevator of the work machine, a chaff auger of the work machine, a grain tank emptying device of the work machine, a post-accelerator of the work machine, a grain auger or a grain tank auger.

In one or some embodiments, the self-propelled agricultural work machine has at least one drive motor, such as an electric motor and/or a diesel engine, for driving the working units and for propelling the self-propelled agricultural work machine at a travel speed with a direction of travel along the agricultural field. An adjustable coupling may be formed between the drive motor and each working unit. A coupling may be understood to be a mechanical, an electrical, a pneumatic and/or a hydraulic coupling between the drive motor and a working unit, whereby the coupling is designed to enable a drive of the coupled working unit starting from the drive motor via the coupling. An adjustable coupling may be designed in such a way that the power transmitted to the coupled working unit by the drive motor via the coupling is adjustable. A coupling may be formed using at least one coupling device or a plurality of coupling devices, such as at least one transmission device, each of which may enable a coupling between the drive motor and the respective working unit.

In one or some embodiments, the self-propelled agricultural work machine has a camera device (e.g., a digital camera) for capturing a digital image of the crop of the agricultural field in surroundings of the self-propelled agricultural work machine. The camera device may be arranged or positioned at the front of the self-propelled agricultural work machine, such as at the front of a driver's cab of the self-propelled agricultural work machine. The camera device may have a mono camera and/or a stereo camera. The camera device may be designed to capture any one, any combination, or all of light visible to humans, light in the near infrared, infrared light, or ultraviolet light for the creation of the digital image. The digital image captured and/or generated by the camera device may comprise image data, such as with pixels.

In one or some embodiments, the self-propelled agricultural work machine includes at least one computational device (e.g., at least one processor or the like) that is configured to act as an adjusting mechanism. In this regard, any discussion herein regarding the computational device or the processor may be imputed to the adjusting mechanism. Similarly, any discussion regarding the adjusting mechanism may relate to at least one processor configured to perform the discussed functions. The at least one processor may be configured, such as designed and/or programmed, to determine a proportion of the harvested material present in the crop using the digital image of the camera device and to adjust at least one working unit and/or the driving speed of the self-propelled agricultural work machine on the basis of this determined proportion of the available harvested material.

In one or some embodiments, the adjusting mechanism may be designed as a control and/or regulating device which causes an adjustment by controlling and/or regulating the agricultural work machine, such as components (e.g., working unit(s)) of the agricultural work machine. The adjusting mechanism may have a computing device (with at least one processor) and a data memory.

The adjusting mechanism may be configured, such as trained and/or programmed, to identify component pixels of a harvestable plant component (e.g., of the harvested material) within the received image data of the digital image corresponding plant pixels of one or more target plants. In this case, the adjusting mechanism may be configured, such as designed and/or programmed, to determine any one, any combination, or all of an edge, a boundary and/or an outline of the component pixels of the harvestable plant component, such as of the harvested material. The adjusting mechanism may be configured, such as trained and/or programmed, to determine a proportion and/or a size of the harvestable plant component, such as of the harvested material, on the basis of the determined edge and/or boundary and/or outline of the identified component pixels.

In one or some embodiments, the proportion of harvested material present in the digital image of the camera device may relate to the number of pixels that represent the harvested material in relation to the total number of pixels of the digital image.

In one or some embodiments, the proportion of harvested material present in the digital image of the camera device may relate to the number and/or dimensions and/or areas of image areas of the digital image that represent the harvested material, relative to the total image area size of the digital image.

Using the evaluation of the digital image of the camera device and the associated use of the adjustments based on the evaluation, inexperienced drivers or experienced drivers may be actively supported in new, unknown situations, among other things, in such a way that the desired yield is achieved or ensured.

In one or some embodiments, the adjusting mechanism is configured, such as designed and/or programmed, to always determine in different areas of the digital image the proportion of the harvested material present in the crop of this area and to cause the adjustment of the at least one working unit and/or the travel or driving speed of the self-propelled agricultural work machine depending on the proportion of the harvested material present in an area of the digital image or a plurality of areas of the digital image. In one or some embodiments, the adjusting mechanism may be configured, such as designed and/or programmed, so that only exactly one area, such as subarea, of the digital image is used to determine the available proportion of the harvested material, while the remaining area of the digital image is ignored when determining the available proportion of the harvested material. Alternatively, the adjusting mechanism may be configured, such as designed and/or programmed, to use a plurality of areas, such as a plurality of subareas, of the digital image to determine the total available proportion of the harvested material, wherein each of the available proportions of the harvested material of the plurality of areas may be weighted differently and then linked to determine the total available proportion of the harvested material. In one or some embodiments, the plurality of areas are selected and/or determined such that these plurality of areas do not overlap.

In one or some embodiments, one of the different areas of the digital image forms a near area or a closer area of an environment of the self-propelled agricultural work machine, and/or that one of the different areas of the digital image forms a remote area of an environment of the self-propelled agricultural work machine, and/or one of the different areas of the digital image forms a middle area of an environment of the self-propelled agricultural work machine between the closer area and the remote area.

In one or some embodiments, the close area (or closer area) of the environment of the self-propelled agricultural work machine may comprise an area of the environment of the self-propelled agricultural work machine that is positioned closer to the camera device of the self-propelled agricultural work machine than the areas of the environment that concern the middle area and the remote area.

The middle area of the environment of the self-propelled agricultural work machine may comprise an area of the environment of the self-propelled agricultural work machine which is positioned closer to the camera device of the self-propelled agricultural work machine than the remote area, and is positioned further away from the camera device of the self-propelled agricultural work machine than the area of the close area.

The remote area of the environment of the self-propelled agricultural work machine comprises an area of the environment of the self-propelled agricultural work machine that is positioned further from the camera device of the self-propelled agricultural work machine than the close area and the middle area.

In one or some embodiments, the adjusting mechanism is configured, such as designed and/or programmed, to cause a short-term precise adjustment of the at least one working unit and/or the travel speed of the self-propelled agricultural work machine depending on the available proportion of the harvested material in the close area of the digital image, and to cause an early rough adjustment of the at least one working unit and/or the driving speed of the self-propelled agricultural work machine depending on the available proportion of the harvested material in the middle area and/or the remote area of the digital image. This may enable optimum use of the areas of the digital image for adjusting the self-propelled agricultural work machine. In one or some embodiments, the adjusting mechanism may be configured to perform and/or execute a Dempster-Shafer procedure.

A short-term precise adjustment (e.g., a more precise adjustment) may have a smaller adjustment parameter range than the early rough adjustment (e.g., a less precise adjustment). In this case, the early rough adjustment may form the adjustment-related starting point of the short-term precise adjustment.

In one or some embodiments, at least one sensor device configured to detect an operating state of the self-propelled agricultural work machine is formed within the self-propelled agricultural work machine, wherein the adjusting mechanism is configured, such as designed and/or programmed, to adjust at least one working unit and/or the travel speed of the self-propelled agricultural work machine depending on the operating state detected using both the at least one sensor device and the determined proportion of the available harvested material. The at least one sensor device for detecting operating states of the work machine may comprise any one, any combination, or all of: at least one sensor for detecting an operating parameter of the drive motor; at least one sensor for detecting an operating parameter of at least one working unit; or at least one sensor for detecting harvested material losses. This may optimize the use of the digital image for adjusting the self-propelled agricultural work machine.

In one or some embodiments, the adjusting mechanism is configured, such as designed and/or programmed, to adjust an immediate accurate adjustment of the at least one working unit and/or the driving speed of the self-propelled agricultural work machine depending on the detected operating state of the self-propelled agricultural work machine.

In one or some embodiments, an immediate accurate adjustment may have a smaller adjustment parameter range than the short-term precise adjustment and the early rough adjustment. In this case, the short-term precise adjustment may form the adjustment starting point for the immediate accurate adjustment. Overall, the adjustment of the self-propelled agricultural work machine may be optimized.

In one or some embodiments, complete plants of the crop each may have a peduncle and a fruit stand (e.g., an infructescence of inflorescence), and that incomplete plants of the infructescence have at most one peduncle, wherein the adjusting mechanism is configured, such as designed and/or programmed, to detect image areas relating to the infructescence of the crop within the digital image and to use them to determine the proportion of the available harvested material. The infructescence may be a simple infructescence in the form of a spike, a spikelet and/or a cob.

In one or some embodiments, the adjusting mechanism is configured to use one or more border polygons to detect the image areas relating to the inflorescences of the harvested material and to use them to adjust at least one working unit and/or the travel or driving speed of the self-propelled agricultural work machine. Such a border polygon may be designed as a closed border polygon which borders the inflorescences of the crop within the digital image, such as for evaluation purposes. In one or some embodiments, the border polygon may be designed as a rectangle in order to reduce the computing power and determination time required to detect the position of the border polygon.

In one or some embodiments, the adjusting mechanism is configured to use a number of pixels of the image areas, such as within the border polygons, with respect to the inflorescences of the crop within the digital image to determine the available proportion of harvested material and to use it to adjust at least one working unit and/or the driving speed of the self-propelled agricultural work machine.

In one or some embodiments, the adjusting mechanism is configured to use rectangular border polygons for detecting the image areas relating to the inflorescences of the harvested material.

In one or some embodiments, the adjusting mechanism is configured to merge overlapping image areas present in the digital image, such as overlapping border polygons, with respect to the inflorescences of the crop to form an image area, such as to form a border polygon. In this regard, it may be provided to merge a plurality of overlapping rectangular border polygons into exactly one matching larger rectangular border polygon. By merging a plurality of overlapping border polygons, for example, the error component of the number of pixels relating to the inflorescences of the harvested material may be reduced, and the adjustment of the at least one working unit and/or the driving speed of the self-propelled agricultural work machine may optimize using the adjusting mechanism.

In one or some embodiments, the adjusting mechanism is configured to include saved information, including any one, any combination, or all of harvested material information, weather information, location information, satellite-based information (e.g., the location of use of the self-propelled agricultural work machine), or field information in a data record (e.g., in an internal and/or external data memory) when determining the proportion of the harvested material present. The harvested material information may be information relating to the type of harvested material. The weather information may have an adjustment-related relevance with respect to the visibility and/or accuracy of the digital image captured by the camera device. The location information, satellite-based information and/or field information may form an adjustment-related relevance with respect to the harvested material type and/or the adjustment, such as adjustment type, of the self-propelled agricultural work machine.

The self-propelled agricultural work machine may have a positioning device (e.g., GPS receiver) for satellite-based detection of a position of the agricultural work machine with respect to the agricultural field in order to detect the satellite-based position information. The positioning device may be designed and/or programmed for positioning using satellite navigation signals, for example to provide position data. At least one satellite device may be used to determine the position of the agricultural work machine with respect to the agricultural field. The satellite device may comprise one and/or more GNSS satellites. The satellite device may comprise any one, any combination, or all of NAVSTAR GPS, GLONASS, Galileo, Beidou, GPS and/or Galileo satellites. The positioning device may be designed and/or programmed for positioning according to the RTK (real-time kinematic) method in which a so-called RTK signal from a stationary ground station is used in addition to the satellite signals in order to determine the position of the agricultural work machine on the agricultural field. In this regard, the stationary ground station may be located outside the agricultural field.

In one or some embodiments, the adjusting mechanism is configured to adjust at least one working unit and/or the driving speed of the self-propelled agricultural work machine based on this determined proportion of the available harvested material in such a way that a predetermined harvested material flow is adjusted by the self-propelled agricultural work machine. In this regard, a preset proportion of the harvested material flow may be programmed into the self-propelled agricultural work machine (e.g., stored in a memory of the self-propelled agricultural work machine that may be input by an operator of the self-propelled agricultural work machine via a touchscreen resident in the cab in the self-propelled agricultural work machine and/or that may be pre-programmed in the memory of the self-propelled agricultural work machine). Responsive to comparison of the determined proportion of the available harvested material with the preset proportion of the harvested material flow, the adjusting mechanism may determine how to adjust at least one working unit and/or the driving speed of the self-propelled agricultural work machine (e.g., increase or decrease the driving speed of the self-propelled agricultural work machine in order to change the proportion of the available harvested material to be closer to the preset proportion of the harvested material flow; modify operation of the working unit(s) in order to change the proportion of the available harvested material to be closer to the preset proportion of the harvested material flow).

In one or some embodiments, the adjusting mechanism is configured to adjust at least one working unit and/or the driving speed of the self-propelled agricultural work machine based on this determined proportion of the available harvested material in such a way that a harvested material loss, such as any one, any combination, or all of grain impurities, broken grain, straw quality and/or the use of fuel, is reduced or minimized by the self-propelled agricultural work machine. The self-propelled agricultural work machine may have at least one sensor or a plurality of sensors for harvested material loss detection.

Furthermore, in one or some embodiments, the invention relates to an adjustment-related use of a digital image of a crop of an agricultural field of an environment of a self-propelled agricultural work machine according to the invention for determining a proportion of harvested material of the crop, and for adjusting at least one working unit and/or a driving speed of the self-propelled agricultural work machine according to the invention depending on the determined proportion of harvested material using the adjusting mechanism of the self-propelled agricultural work machine, so that a throughput of a harvested material flow through the self-propelled agricultural work machine is controlled with reduced or minimized harvested material losses using the adjustment of at least one working unit and/or the driving speed of the self-propelled agricultural work machine. The self-propelled agricultural work machine may have one and/or more details described above or below.

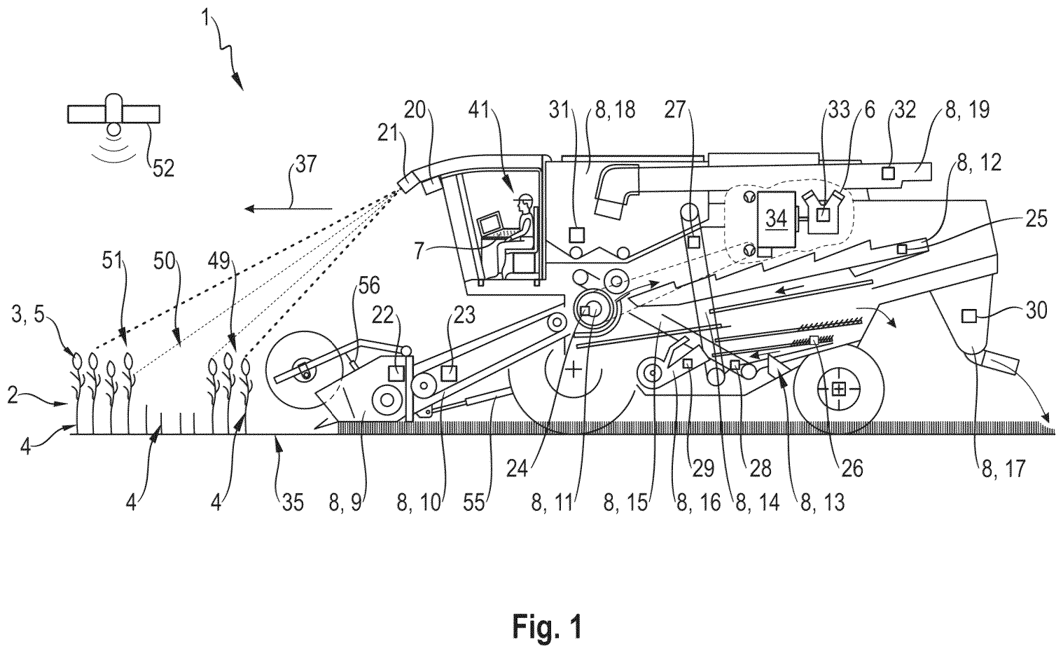

Referring to the figures, FIG. 1 shows a self-propelled agricultural work machine 1 according to the invention during use on an agricultural field 35. The self-propelled agricultural work machine 1 illustrated in FIG. 1 is a self-propelled combine harvester by way of example. Alternatively, self-propelled agricultural work machine 1 may comprise a self-propelled forage harvester. Example combine harvesters include US Patent Application Publication No. 2024/0081182 A1 and US Patent Application Publication No. 2024/0196796 A1, both of which are incorporated by reference herein in their entirety. Example forage harvesters include US Patent Application Publication No. 2023/0232740 A1 and US Patent Application Publication No. 2024/0196796 A1, both of which are incorporated by reference herein in their entirety.

The agricultural field 35 may, for example, have a plant crop 2 with a plurality of different formed areas, such as differently formed areas 49, 50 and 51, wherein the plant crop 2 has complete plants in areas 49 and 51, each of which has a peduncle 4 and an associated inflorescence 5 which forms a harvested material 3, whereas in area 50, there are at most peduncles 4 which do not form a harvested material 3 (e.g., which form a non-existent proportion of the harvested material based on the one or more image areas indicative of the peduncles, effectively so that this area 50 does not form any harvested material 3).

In one or some embodiments, the self-propelled combine harvester has a plurality of working units 8 for picking up, processing and forwarding the harvested material 3 of the plant crop 2 of the agricultural field 35. While traveling along the direction of travel 37 through the plant crop 2, the self-propelled combine harvester collects the harvested material 3 with a cutting unit 9. An inclined conveyor 10 conveys this harvested material 3 to the threshing unit 11. In the threshing unit 11, a separating device 12 and a conveying and cleaning device 13, the grains may be separated from the rest of the harvested material so that a flow of harvested material is formed. The cleaning device 13 may have a blower 16 for cleaning. The combine harvester may have a grain elevator 14 for conveying a flow of harvested material from the conveying and cleaning device 13 to a grain tank 18 of the combine harvester. Furthermore, the combine harvester may have a chaff auger 15 and a straw chopper 17. In addition, the self-propelled combine harvester may have a grain tank emptying device 19 for emptying the grain tank 18. These previously mentioned components of the self-propelled combine harvester form a plurality of working units 8 which are designed to pick up, process and/or forward the harvested material and are driven by a drive motor 6. In addition to driving the working units 8, the drive motor 6 is configured to propel the self-propelled agricultural work machine 1 at a speed in the direction of travel 37 along the agricultural field 35. The drive motor 6 may be coupled to the working units 8 for driving using one or more coupling devices 34.

In one or some embodiments, the self-propelled agricultural work machine 1 has a camera device 21 which is arranged or positioned at the front of the self-propelled agricultural work machine 1. The camera device 21 is configured to capture images, such as digital image 21a of the plant crop 2 of the agricultural field 35 in the front environment of the self-propelled agricultural work machine 1 with respect to the direction of travel 37.

In one or some embodiments, the self-propelled agricultural work machine 1 has an adjusting mechanism 7 which is provided and configured to determine, using the digital image 21a of the camera device 21, a proportion of the harvested material 3 present in the plant crop 2 in the form of the inflorescence 5 and, based on this determined proportion of the available harvested material 3, to automatically adjust at least one working unit 8, such as automatically control actuator 55 or 56 of a working unit 8, and/or to automatically adjust the driving speed of the self-propelled agricultural work machine 1, such as automatically and therefore without any effort on the part of a driver 41 (e.g., the adjusting mechanism 7 automatically sends one or more commands to the modify control actuator 55 or 56; the adjusting mechanism 7 automatically sends one or more commands to the modify the speed of the self-propelled agricultural work machine 1). In addition, in one or some embodiments, the self-propelled agricultural work machine 1 may have a sensor device 20, such as in the form of a camera and/or a LIDAR system, for detecting environmental conditions of the self-propelled agricultural work machine 1.

Within the self-propelled agricultural work machine 1, at least one sensor device, such as any one, any combination, or all of sensor devices 22, 23, 24, 25, 26, 27, 28, 29, 30, 31, 32, 33 are designed to detect an operating state of the self-propelled agricultural work machine 1, such as of a working unit 8 and/or of the drive motor 6. In this regard, the adjusting mechanism 7 is configured to adjust at least one working unit 8 and/or the driving speed of the self-propelled agricultural work machine 1 depending on both the operating state detected by any one, any combination, or all of the sensor devices 22, 23, 24, 25, 26, 27, 28, 29, 30, 31, 32, 33 and the determined proportion of the available harvested material 3.

The sensor device 22 of the working unit 8, which is designed as a cutting unit 9, is designed and/or positioned to detect operating states of the cutting unit 9. The sensor device 23 of the working unit 8, which is designed as an inclined conveyor 10, is designed and/or positioned to detect operating states of the inclined conveyor 10. The sensor device 24 of the working unit 8, which is designed as a threshing unit 11, is designed and/or positioned to detect operating states of the threshing unit 11. The sensor device 25 of the working unit 8, which is designed as a separating device 12, is designed and/or positioned to detect operating states of the separating device 12. The sensor device 26 of the working unit 8, which is designed as a conveying and cleaning device 13, is designed and/or positioned to detect operating states of the conveying and cleaning device 13. The sensor device 27 of the working unit 8, which is designed as a grain elevator 14, is designed and/or positioned to detect operating states of the grain elevator 14. The sensor device 28 of the working unit 8, which is designed as a chaff auger 15, is designed and/or positioned to detect operating states of the chaff auger 15. The sensor device 29 of the working unit 8, which is designed as a blower 16, is designed and/or positioned to detect operating states of the blower 16. The sensor device 30 of the working unit 8, which is designed as a straw chopper 17, is designed and/or positioned to detect operating states of the straw chopper 17. The sensor device 31 of the working unit 8, which is designed as a grain tank 18, is designed and/or positioned to detect operating states of the grain tank 18. The sensor device 33 of the drive motor 6 is designed and/or positioned to detect operating states, such as the speed, of the drive motor 6. The sensor device 32 of the working unit 8, which is designed as a grain tank emptying device 19, is designed and/or positioned to detect operating states of the grain tank emptying device 19. A sensor device, which is not shown, may detect drive power as an indicator of the throughput. Thus, sensor devices 22, 23, 24, 25, 26, 27, 28, 29, 30, 31, 32, 33 may send the operating state(s) of the respective working unit 8 to the adjusting mechanism 7 for use as discussed herein.

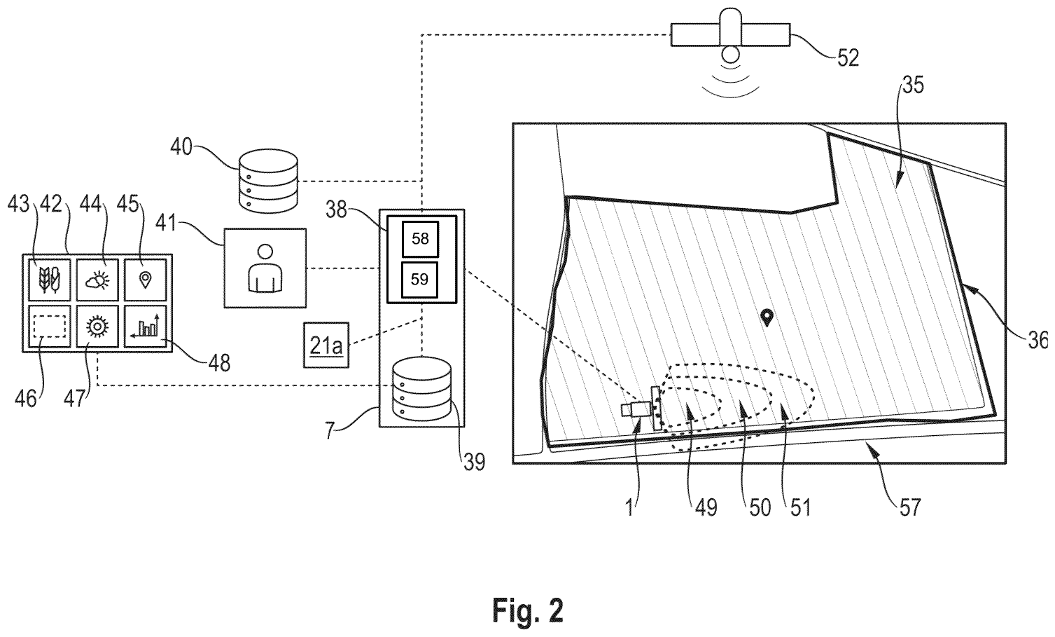

FIG. 2 shows a top view of the agricultural use of the self-propelled agricultural work machine 1 according to the invention on the agricultural field 35, which is delimited from the non-field area 57 by field boundaries 36. The adjusting mechanism 7 may have a calculating device 38 and an internal data memory 39. Calculating device 38 may include at least one processor 58 and at least one memory 59. The at least one processor 58 and at least one memory 59 may be in communication with one another. In one or some embodiments, the processor 58 may comprise a microprocessor, controller, PLA, or the like. Similarly, the memory 59 may comprise any type of storage device (e.g., any type of memory). Though the processor 58 and the memory 59 are depicted as separate elements, they may be part of a single machine, which includes a microprocessor (or other type of controller) and a memory. Alternatively, the processor 58 may rely on the memory 59 for all of its memory needs. The memory 59 may comprise a tangible computer-readable medium that include software that, when executed by the processor 58 is configured to perform any one, any combination, or all of the functionality described herein, such as the functionality of the adjusting mechanism 7. Still alternatively, processor 58 may use other memory, such as internal data memory 39 and/or external data memory 40.

The processor 58 and the memory 59 are merely one example of a computational configuration for the calculating device 38. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Alternatively or additionally, the adjusting mechanism 7 may be connected (e.g., wired and/or wirelessly) to communicate with an internal data memory 39. Alternatively or additionally, the adjusting mechanism 7 may be connected to communicate with at least one satellite 52 for determining the position of the self-propelled agricultural work machine 1. A data record 42 may be saved in the data memory 39 and/or 40, in which harvested material information 43, weather information 44, location information 45, satellite-based information 52 and/or field information 46 are saved and may additionally be used when determining the proportion of the available harvested material 3 by means of the adjusting mechanism 7.

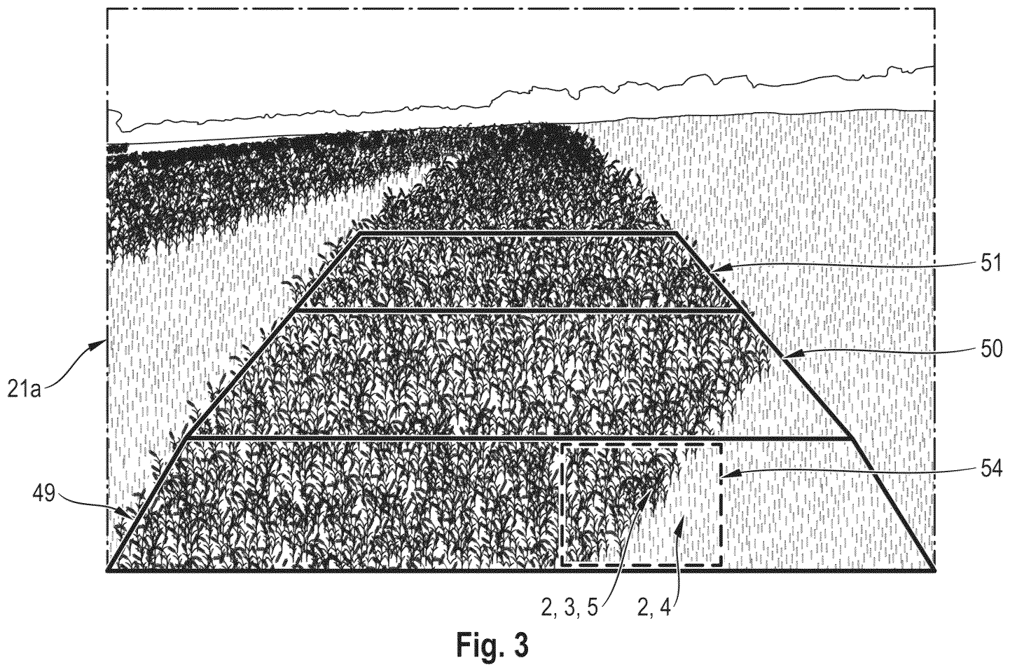

As indicated in FIG. 1 and FIG. 2, different areas 49, 50, 51 of the agricultural field are recorded using the camera device 21. As indicated in FIG. 3, the adjusting mechanism 7 is configured to determine in one, some or each of these different areas 49, 50, 51 of the digital image 21a the proportion of available harvested material 3 in the plant crop 2 of this area 49, 50, 51 and to cause the adjustment of the at least one working unit 8 and/or the driving speed of the self-propelled agricultural work machine 1 depending on the proportion of available harvested material 3 in an area 49, 50, 51 of the digital image 21a or a plurality of areas 49, 50, 51 of the digital image 21a.

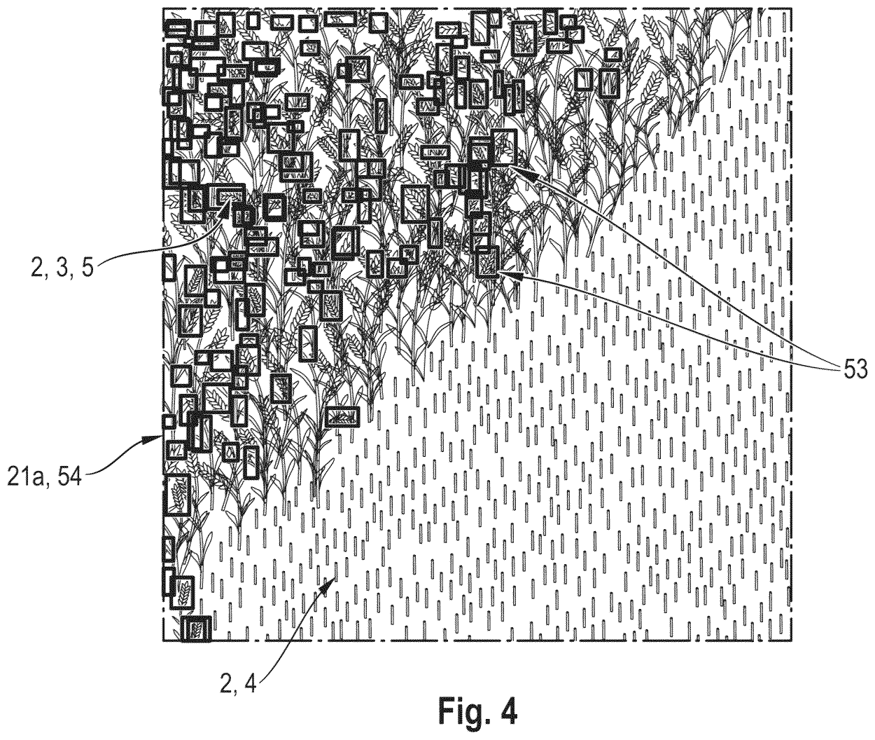

One of the different areas 49, 50, 51 of the digital image 21a forms a close area 49, a middle area 50 and a remote area 51 of the environment of the self-propelled agricultural work machine 1. FIG. 3 shows an example that the close area 49 is not completely formed with harvested material 3 in the form of inflorescence 5, but also has an area with only peduncles 4. The subsection 54 of the close area 49 is shown enlarged in FIG. 4.

Complete plants of the plant crop 2 may each have a peduncle 4 and one or more inflorescence 5, while incomplete plants of the plant crop 2 have at most one peduncle 4, wherein the adjusting mechanism 7 is provided and configured to detect image areas relating to the inflorescence(s) 5 of the plant crop 2 within the digital image 21a and to use them to determine the available proportion of the harvested material 3. The adjusting mechanism 7 is configured to use border polygons 53 to detect the image areas relating to the inflorescences 5 of the plant crop 2.

The available proportion of the harvested material 3 in the digital image 21a of the camera device 21 may relate to the number and/or dimensions and/or areas of image areas of the border polygons 53 of the digital image 21a, which may represent the harvested material, in relation to the total image area size of the digital image 21a.

Alternatively or additionally, the proportion of the harvested material 3 present in the digital image 21a of the camera device 21 may relate to the number of pixels that represent the harvested material 3 in relation to the total number of pixels of the digital image 21a.

The adjusting mechanism 7 may be configured to use rectangular border polygons 53 to detect the image areas relating to the inflorescences 5 of the plant crop 2.

In so doing, corresponding plant pixels of harvestable plant component within the obtained image data, such as digital image 21a may be identified and/or counted with respect to one or more target plant crops 2 and/or considered in relation to the total number of pixels of the image data in order to determine adjustment parameters for the work machine.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Self-propelled agricultural work machine
2 Plant crop
3 Harvested material
4 Peduncle
5 Inflorescence
6 Drive motor
7 Adjusting mechanism
8 Work unit
9 Cutting unit
10 Inclined conveyor
11 Threshing unit
12 Separating device
13 Conveying and cleaning device
14 Grain elevator
15 Return auger
16 Fan
17 Straw chopper
18 Grain tank
19 Grain tank emptying device
20 Sensor device for detecting environmental conditions
21 Camera device for detecting a digital image
21a Digital image
22 Sensor device for detecting operating states
23 Sensor device for detecting operating states
24 Sensor device for detecting operating states
25 Sensor device for detecting operating states
26 Sensor device for detecting operating states
27 Sensor device for detecting operating states
28 Sensor device for detecting operating states
29 Sensor device for detecting operating states
30 Sensor device for detecting operating states
31 Sensor device for detecting operating states
32 Sensor device for detecting operating states
33 Sensor device for detecting operating states
34 Coupling device
35 Agricultural field
36 Field boundary
37 Driving direction
38 Computer device
39 Internal data memory
40 External data memory
41 Driver
42 Data record
43 Harvested material information
44 Weather information
45 Location information
46 Field information
47 Work machine parameters
48 Operating states
49 Close area
50 Middle area
51 Remote area
52 Satellite
53 Border polygon with image area
54 Subsection
55 Actuator
56 Actuator
57 Non-field area
58 Processor
59 Memory

1. A self-propelled agricultural work machine comprising:
one or more working units configured to perform one or more of collecting, processing and forwarding harvested material of a crop of an agricultural field;
at least one drive motor configured to drive the one or more working units and to propel the self-propelled agricultural working machine at a travel speed along the agricultural field;
at least one camera device configured to capture one or more images of the crop of the agricultural field in an environment of the self-propelled agricultural work machine;
at least one processor configured to:
automatically determine a proportion of the harvested material present in the crop using the one or more images of the camera device; and
automatically adjust, based on the proportion of the harvested material present in the crop, one or both of: at least one working unit of the one or more working units; or the travel speed of the self-propelled agricultural work machine.

2. The self-propelled agricultural work machine of claim 1, wherein the at least one processor is configured to determine in a plurality of different areas of the one or more images the proportion of harvested material in the crop in each respective area of the plurality of different areas; and
wherein the at least one processor is configured to automatically adjust, based on the proportion of the harvested material present in the crop in at least one respective area of the plurality of different areas, by commanding one or both of: at least one working unit to adjust the at least one of the one or more working units; or the at least one drive motor to adjust the travel speed of the self-propelled agricultural work machine.

3. The self-propelled agricultural work machine of claim 2, wherein the plurality of different areas comprise at least one of:
a closer area of the environment of the self-propelled agricultural work machine;
a remote area of the environment of the self-propelled agricultural work machine; or
a middle area of the environment of the self-propelled agricultural work machine between the closer area and the remote area; and
wherein the at least one processor is configured to automatically adjust based on the proportion of the harvested material present in the crop in at least one of the closer area, the remote area, or the middle area.

4. The self-propelled agricultural work machine of claim 3, wherein the at least one processor is configured to perform one or both of:
control a more precise adjustment of one or both of the at least one working unit or the travel speed of the self-propelled agricultural work machine depending on the proportion of harvested material in the closer area; or
control a less precise adjustment of one or both of the at least one working unit or the travel speed of the self-propelled agricultural work machine depending on the proportion of harvested material in one or both of the middle area or the remote area.

5. The self-propelled agricultural work machine of claim 1, wherein the at least one processor is configured to determine in a plurality of different areas of the one or more images the proportion of harvested material in the crop in each respective area of the plurality of different areas; and
wherein the at least one processor is configured to automatically adjust, based on the proportion of the harvested material present in the crop in each respective area of the plurality of different areas, by commanding one or both of: the at least one working unit; or the at least one drive motor to adjust the travel speed of the self-propelled agricultural work machine.

6. The self-propelled agricultural work machine of claim 5, wherein the plurality of different areas comprise:
a closer area of the environment of the self-propelled agricultural work machine;
a remote area of the environment of the self-propelled agricultural work machine; or
a middle area of the environment of the self-propelled agricultural work machine in between the closer area and the remote area; and
wherein the at least one processor is configured to automatically adjust based on the proportion of the harvested material present in the crop in each of the closer area, the remote area, or the middle area.

7. The self-propelled agricultural work machine of claim 6, wherein the at least one processor is configured to:
control a more precise adjustment of one or both of the at least one working unit or the travel speed of the self-propelled agricultural work machine depending on the proportion of harvested material in the closer area; and
control a less precise adjustment of one or both of the at least one working unit or the travel speed of the self-propelled agricultural work machine depending on the proportion of harvested material in one or both of the middle area or the remote area.

8. The self-propelled agricultural work machine of claim 1, further comprising at least one sensor device configured to detect an operating state of the self-propelled agricultural work machine; and
wherein the at least one processor is configured to adjust one or both of the at least one working unit or the travel speed of the self-propelled agricultural work machine depending on both of the operating state detected by the at least one sensor device and the proportion of the harvested material that is available.

9. The self-propelled agricultural work machine of claim 8, wherein the at least one processor is configured to make an immediate accurate adjustment of one or both of the at least one working unit or the travel speed of the self-propelled agricultural work machine depending on the operating state of the self-propelled agricultural work machine; and
wherein the immediate accurate adjustment comprises a smaller adjustment parameter range than a short-term precise adjustment.

10. The self-propelled agricultural work machine of claim 1, wherein complete plants of the crop each have a peduncle and an infructescence of inflorescence;
wherein incomplete plants of the crop have at most one peduncle;
wherein the at least one processor is configured to:
detect one or more image areas indicative of the inflorescences of the crop within the one or more images and to determine the proportion of the harvested material present based on the one or more image areas indicative of the inflorescences; or
detect one or more image areas indicative of the peduncles of the crop within the one or more images and to determine a non-existent proportion of the harvested material based on the one or more image areas indicative of the peduncles.

11. The self-propelled agricultural work machine of claim 10, wherein the at least one processor is configured to use one or more border polygons to detect the one or more image areas relating to the inflorescences of the crop.

12. The self-propelled agricultural work machine of claim 11, wherein the at least one processor is configured to use a number of pixels of the one or more image areas within the border polygons with respect to the inflorescences of the crop within the one or more images in order to determine the proportion of the harvested material.

13. The self-propelled agricultural work machine of claim 12, wherein the at least one processor is configured to use one or more rectangular border polygons to detect the one or more image areas relating to the inflorescences of the crop.

14. The self-propelled agricultural work machine of claim 12, wherein the at least one processor configured to combine overlapping image areas present in the one or more images with respect to the inflorescences of the crop to form a respective image area.

15. The self-propelled agricultural work machine of claim 14, wherein the at least one processor configured to combine overlapping border polygons present in the one or more images with respect to the inflorescences of the crop to form a border polygon.

16. The self-propelled agricultural work machine of claim 1, wherein the at least one processor is configured to use one or more of harvested material information, weather information, location information, satellite-based information or field information in determining the proportion of the harvested material.

17. The self-propelled agricultural work machine of claim 1, wherein the at least one processor is configured to use each of harvested material information, weather information, location information, satellite-based information or field information in determining the proportion of the harvested material.

18. The self-propelled agricultural work machine of claim 1, wherein the at least one processor is configured to adjust one or more of the at least one working unit or the travel speed of the self-propelled agricultural work machine based on the proportion of the harvested material so that the adjustment results in a predetermined harvested material flow being adjusted by the self-propelled agricultural work machine.

19. The self-propelled agricultural work machine of claim 1, wherein the at least one processor is configured to adjust the one or more of the at least one working unit or the travel speed of the self-propelled agricultural work machine based on the proportion of the harvested material so that the adjustment results in reduction in a loss of the harvested material from the self-propelled agricultural work machine.

20. A method for controlling a self-propelled agricultural work machine comprising:
operating the self-propelled agricultural work machine, the self-propelled agricultural work machine comprising:
one or more working units configured to perform one or more of collecting, processing and forwarding harvested material of a crop of an agricultural field;
at least one drive motor configured to drive the one or more working units and to propel the self-propelled agricultural working machine at a travel speed along the agricultural field;
at least one camera device configured to capture one or more images of the crop of the agricultural field in an environment of the self-propelled agricultural work machine;
automatically determining a proportion of the harvested material present in the crop using the one or more images of the camera device; and
automatically adjusting, based on the proportion of the harvested material present in the crop, one or both of: at least one working unit of the one or more working units; or the travel speed of the self-propelled agricultural work machine.
